(19) United States
(12) Patent Application Publication
(10) Pub. No.: US 2024/0393505 A1
(43) Pub. Date: Nov. 28, 2024

(54) OPTICAL LENS DEVICE HAVING AN ANTI-FOG THIN FILM AND MANUFACTURING METHOD THEREOF

(71) Applicant: FORESIGHT OPTICAL LTD., Tainan (TW)

(72) Inventors: TIEN-SHU WU, Tainan (TW); YEN-TING WU, Tainan (TW)

(21) Appl. No.: 18/212,628

(22) Filed: Jun. 21, 2023

(30) Foreign Application Priority Data
May 23, 2023 (TW) 112119192

(51) Int. Cl. G02B 1/18; B32B 27/08; B32B 37/12

(52) U.S. Cl. CPC G02B 1/18; B32B 27/08; B32B 37/1207; B32B 2551/00

(57) ABSTRACT

A manufacturing method for an optical lens device includes: providing an optical substrate layer or an optical laminated substrate layer with a first front side surface and a second rear side surface; processing a heat-setting treatment procedure on a flexible anti-fog film for a predetermined time to form a heat-setting-treated anti-fog film, with the heat-setting-treated anti-fog film corresponding to the second rear side surface of optical substrate layer or optical laminated substrate layer; providing an optical adhesive layer on predetermined area of the second rear side surface of optical substrate layer or optical laminated substrate layer; correspondingly adhering the heat-setting-treated anti-fog film to the second rear side surface of optical substrate layer or optical laminated substrate layer.

### BACKGROUND OF THE INVENTION

### 1. Field of the Invention

The present invention relates to an optical lens device having an anti-fog thin film and manufacturing method thereof. Particularly, the present invention relates to the optical lens device having a heat setting treated anti-fog thin film and manufacturing method thereof.

### 2. Description of the Related Art

For example, U.S. Pat. No. 10,259,744, entitled “Process for producing an optical glass with an anti-fog coating,” discloses an anti-fog coating optical glass structure and a manufacturing method for producing the same, with providing a function of multiple anti fog.

FIG. 1 shows a schematic side view of an anti-fog coating optical glass structure described in U.S. Pat. No. 10,259,744 in accordance with the prior art. Turning now to FIG. 1, the anti-fog coating optical glass structure includes a main glass body, a front surface glass layer, a front surface anti-fog coating layer and a rear surface glass layer. The front surface anti-fog coating layer is formed from an anti-fog coating layer which has a hydrophilic coating layer with Si—C bonds.

With continued reference to FIG. 1, the front surface anti-fog coating layer is provided on the front surface glass layer of main glass body for reducing or minimizing contact angles of water droplets on the front surface glass layer, thereby preventing the front surface glass layer from clouding (e.g., moisture mist or fog) adhering to thereto.

However, there is no anti-fog layer or anti-fog coating further provided on the rear surface glass layer of the main glass body such that high moisture of air mist, human body sweat moisture or breathing moisture of users are usually apt to generate clouding or fog on the rear surface glass layer of the main glass body.

Another Taiwanese Patent Publication No. 1754919, entitled “Multi-functional anti-fog optical lens device,” discloses a multi-functional anti-fog optical lens device, comprising a substrate layer, a functional layer and an anti-fog layer, with the substrate layer provided with a first front side surface and a second rear side surface.

As mentioned above, the functional layer is provided on the second rear side surface of substrate layer to provide an optical function or property thereon. Furthermore, the anti-fog layer is also provided on the second rear side surface of substrate layer to provide an anti-fog function or property to prevent lifting various fogs thereon, with the anti-fog layer also formed on the functional layer.

However, the multi-functional anti-fog optical lens device does not teach how to process to form the anti-fog layer on the functional layer and the second rear side surface of substrate layer so as to simplify difficulties or complications in an entire process for manufacturing the multi-functional anti-fog optical lens device.

Another Taiwanese Patent Publication No. 1588516, entitled “Manufacturing method of anti-fog optical lenses and an anti-fog optical lens device produced thereby,” discloses an anti-fog optical lens device, comprising a lens body, a PC (polycarbonate) material layer, a PC film and an anti-fog film.

As mentioned above, the manufacturing method includes the steps: combining the PC film and the anti-fog film with an optical adhesive to form a composite PC film and anti-fog film combination; and processing an injection molding on the lens body and the composite PC film and anti-fog film combination with a PC material to form an injection molding body.

However, provided in the injection molding body are the lens body, the PC material layer, the PC film and the anti-fog film to form as a multi-layer injection molding body. Disadvantageously, the manufacturing method for an anti-fog optical lens must require an optical adhesive-dispensing procedure and an injection molding procedure such that it has sophistications in the entire process and structure.

Another Taiwanese Utility-Model Patent Publication No. M542774, entitled “Anti-fog and photochromic optical lens,” discloses an anti-fog and photochromic optical lens device, comprising a main lens body, an anti-fog thin layer and a photochromic thin layer, with the lens body having a front side surface and a rear side surface, with the anti-fog thin layer provided on the rear side surface of main lens body, with the photochromic thin layer provided on the front side surface of main lens body.

As mentioned above, the anti-fog thin layer is formed from a first PC (polycarbonate) film and an anti-fog film combined with an adhesive to form a first laminated combination while the photochromic thin layer is formed from a photochromic material sandwiched between a second PC film and a third PC film to form a second laminated combination.

However, the main lens body, the anti-fog thin layer and the photochromic thin layer must be combined with several PC films to form the first laminated combination and the second laminated combination. Disadvantageously, a manufacturing method for the anti-fog and photochromic optical lens must require an optical adhesive-dispensing procedure and a photochromic material-dispensing procedure such that it has sophistications in the entire process and structure.

Another Taiwanese Utility-Model Patent Publication No. M544409, entitled “Anti-fog lens,” discloses an anti-fog optical lens device, comprising a main lens body, a plastic thin film, a UV (ultraviolet) adhesive layer and an anti-fog thin film, with the lens body having a front side surface and a rear side surface.

As mentioned above, the UV adhesive layer is provided to adhere the plastic thin film to the anti-fog thin film and further hardened by a UV light beam so as to combine the plastic thin film with the anti-fog thin film to form an anti-fog laminated layer. Furthermore, the main lens body is molded by inject-molding on a predetermined surface of the plastic thin film formed on the anti-fog laminated layer.

However, a manufacturing method for processing the main lens body, the plastic thin film, the UV adhesive layer and the anti-fog thin film must require an optical UV adhesive-dispensing and hardening procedure and an inject-molding procedure such that disadvantageously it has sophistications in the entire process and structure.

Another Taiwanese Utility-Model Patent Publication No. M552108, entitled “Anti-fog lens and goggle device,” discloses an anti-fog optical lens device, comprising a protective layer and an anti-fog layer, with the protective layer having a front side surface and a rear side surface.

As mentioned above, the protective layer is selected from a PC (polycarbonate) layer while the anti-fog layer is selected from a PET (polyethylene terephthalates) layer or a TAC (tri-acetyl cellulose) layer. The PET layer or the TAC layer is formed on the rear side surface of protective layer by means of injection molding or hot pressing. Furthermore, there is no optical functional layer provided between the protective layer and the anti-fog layer or on a combination thereof.

However, a manufacturing method for forming the PET layer or the TAC layer on the rear side surface of protective layer must require an injection-molding procedure or a hot pressing procedure such that disadvantageously it has sophistications and difficulties in the entire process and structure.

Another Taiwanese Utility-Model Patent Publication No. M553811, entitled “Anti-fog thin-frame ski goggle,” discloses an anti-fog optical lens device, including a main lens body, with the main lens body comprising a light-transparent layer, a front side anti-fog layer, a filtering layer and a rear side anti-fog layer, with the main lens body having a front side surface and a rear side surface.

As mentioned above, the front side anti-fog layer and the filtering layer are formed on the front side surface of main lens body by means of dip-coating while the rear side anti-fog layer is formed on the rear side surface of main lens body. Furthermore, there is no optical functional layer provided on the rear side surface of main lens body.

However, a manufacturing method for dip-coating the front side anti-fog layer and the filtering layer on the front side surface of main lens body must require a repeated dip-coating procedure. Disadvantageously, there is no teaching how to simplify forming the rear side anti-fog layer on the rear side surface of main lens body or to reduce a total thickness of rear side anti-fog layer and main lens body.

Another Taiwanese Utility-Model Patent Publication No. M583056, entitled “Anti-fog photochromic optical lens,” discloses an anti-fog photochromic optical lens device, comprising a lens body, a first transparent plastic layer, a photochromic material layer, a second transparent plastic layer and an anti-fog thin film, with the lens body having a front side surface and a rear side surface.

As mentioned above, the photochromic material layer is sandwiched between the first transparent plastic layer and the second transparent plastic layer, with adhering the photochromic material layer to the first transparent plastic layer and the second transparent plastic layer to form a photochromic laminated layer. Furthermore, the anti-fog thin film is adhered to the photochromic laminated layer to form an anti-fog photochromic composite layer.

However, a manufacturing method for forming the photochromic laminated layer and further forming the anti-fog photochromic composite layer must require several adhesive-dispensing procedures and several adhering procedures such that disadvantageously it has sophistications and difficulties in the entire process and structure.

However, there is a need of improving the conventional anti-fog optical lens device for simplifying a structure and a manufacturing method thereof. The above-mentioned patents and patent application publications are incorporated herein by reference for purposes including, but not limited to, indicating the background of the present invention and illustrating the situation of the art.

### SUMMARY OF THE INVENTION

The primary objective of this invention is to provide an optical lens device having an anti-fog thin film and manufacturing method thereof. An optical substrate layer (or optical laminated substrate layer) is provided with a first front side surface and a second rear side surface and a flexible anti-fog film is processed with a heat-setting treatment procedure for a predetermined time to form a heat-setting-treated anti-fog film, with the heat-setting-treated anti-fog film corresponding to the second rear side surface of optical substrate layer (or optical laminated substrate layer), with providing an optical adhesive layer on a predetermined area of the second rear side surface of optical substrate layer, with correspondingly adhering the heat-setting-treated anti-fog film to the second rear side surface of optical substrate layer (or optical laminated substrate layer). Advantageously, the optical lens device of the present invention is successful in improving a designed structure of optical lens devices.

The manufacturing method of the optical lens device in accordance with an aspect of the present invention includes:
providing an optical substrate layer or an optical laminated substrate layer with a first front side surface and a second rear side surface;
processing a heat-setting treatment procedure on a flexible anti-fog film for a predetermined time to form a heat-setting-treated anti-fog film, with the heat-setting-treated anti-fog film corresponding to the second rear side surface of optical substrate layer or optical laminated substrate layer;
providing an optical adhesive layer on predetermined area of the second rear side surface of optical substrate layer; and
correspondingly adhering the heat-setting-treated anti-fog film to the second rear side surface of optical substrate layer or optical laminated substrate layer.

In a separate aspect of the present invention, the heat-setting-treated anti-fog film is selectively formed with a flat surface heat-setting-treated film, a curved surface heat-setting-treated film, a hyperbola surface heat-setting-treated film, a spherical surface heat-setting-treated film or an aspherical surface heat-setting-treated film by processing the heat-setting treatment procedure.

In a further separate aspect of the present invention, the heat-setting treatment procedure is processed in a predetermined temperature ranging between 100° C. to 140° C.

In yet a further separate aspect of the present invention, the predetermined time of heat-setting treatment procedure ranges is about 1 minute to 40 minute.

In yet a further separate aspect of the present invention, the flexible anti-fog film has a front side surface and a rear side surface, with selectively processing the heat-setting treatment procedure on the front side surface, the rear side surface or both.

The optical lens device in accordance with another aspect of the present invention includes:
an optical substrate layer or an optical laminated substrate layer provided with a first front side surface and a second rear side surface;
at least one optical adhesive layer provided on a predetermined area of the second rear side surface of optical substrate layer or optical laminated substrate layer; and
at least one heat-setting-treated anti-fog film formed by processing a heat-setting treatment procedure on a flexible anti-fog film for a predetermined time, with the heat-setting-treated anti-fog film corresponding to the second rear side surface of optical substrate layer or optical laminated substrate layer, with the heat-setting-treated anti-fog film correspondingly adhering to the second rear side surface of optical substrate layer or optical laminated substrate layer;
wherein the heat-setting-treated anti-fog film provides an anti-fog function on the second rear side surface of optical substrate layer or optical laminated substrate layer, with a combination of the heat-setting-treated anti-fog film and the second rear side surface of optical substrate layer or optical laminated substrate layer enhancing an entire structure.

In a separate aspect of the present invention, the optical substrate layer or the optical laminated substrate layer is selected from a glass substrate layer, a plastic substrate layer, an eco-friendly plastic substrate layer, a PC (polycarbonate) substrate layer, a PMMA (poly(methyl methacrylate) substrate layer, a PA (polyamide or Nylon) substrate layer, a COP (cyclic olefin polymer) substrate layer, a COC (cyclic olefin copolymer) substrate layer, a COB (cyclic block copolymer) substrate layer or combinations thereof.

In a further separate aspect of the present invention, the flexible anti-fog film is selected from a PP (polypropylene) material film, a PET (polyethylene terephthalates) material film, a TAC (polyethylene terephthalates) material film or combinations thereof.

In yet a further separate aspect of the present invention, the heat-setting-treated anti-fog film is selectively formed with a flat surface heat-setting-treated film, a curved surface heat-setting-treated film, a hyperbola surface heat-setting-treated film, a spherical surface heat-setting-treated film or an aspherical surface heat-setting-treated film by processing the heat-setting treatment procedure.

In yet a further separate aspect of the present invention, the second rear side surface of optical substrate layer or optical laminated substrate layer further includes an optical functional layer, with the optical functional layer selected from a protective layer, an electroplating layer, a polarization microstructure layer, an anti-reflection layer, a polarization thin-film layer, a microstructure layer, a photochromic layer, an anti-blue layer, an anti-blue UV layer, an anti-infrared layer or combinations thereof.

Further scope of the applicability of the present invention will become apparent from the detailed description given hereinafter. However, it should be understood that the detailed description and specific examples, while indicating preferred embodiments of the invention, are given by way of illustration only, since various will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 is a schematic side view of an anti-fog coating optical glass structure described in U.S. Pat. No. 10,259,744 in accordance with the prior art.

FIG. 2 is a schematic side view of an optical lens device having an anti-fog thin film in accordance with a first preferred embodiment of the present invention.

FIG. 3 is a schematic side view of an optical lens device having an anti-fog thin film in accordance with a second preferred embodiment of the present invention.

FIG. 4 is a flow chart of a manufacturing method of the optical lens device having an anti-fog thin film in accordance with a preferred embodiment of the present invention.

FIG. 5 is a schematic side view of an optical lens device having an anti-fog thin film in accordance with the third preferred embodiment of the present invention.

FIG. 6 is a schematic side view of an optical lens device having an anti-fog thin film in accordance with a fourth preferred embodiment of the present invention.

FIG. 7 is a schematic side view of an optical lens device having an anti-fog thin film in accordance with a fifth preferred embodiment of the present invention.

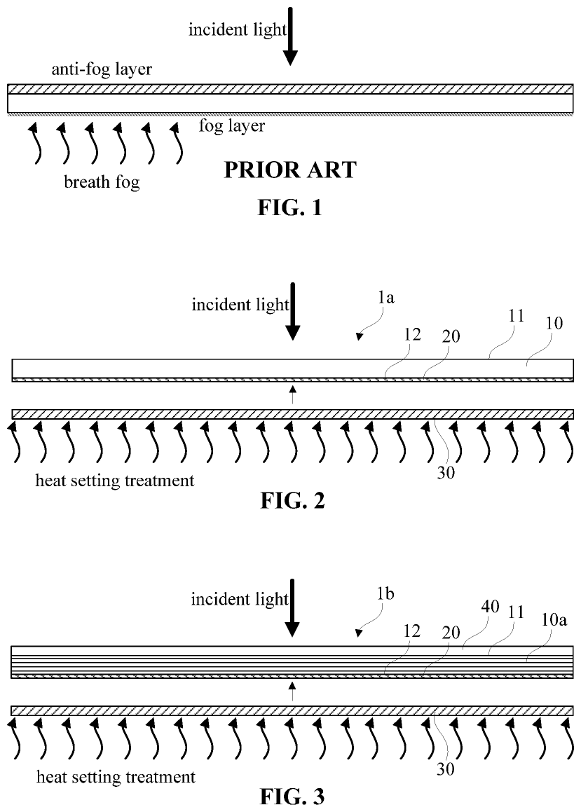

### DETAILED DESCRIPTION OF THE INVENTION

It is noted that an optical lens device having an anti-fog thin film and manufacturing method thereof in accordance with the preferred embodiment of the present invention can be applicable to various glasses (e.g., ophthalmic glasses), various sunglasses, various smart glasses, various sport glasses (e.g., motorcycle-riding glasses), various goggles, various 3D glasses devices, various VR wearable glasses devices, various AR wearable glasses devices or other optical devices various glasses (e.g., ophthalmic glasses), various sunglasses, various smart glasses, various sport glasses (e.g., motorcycle-riding glasses), various goggles, various 3D glasses devices, various VR wearable glasses devices, various AR wearable glasses devices or other optical devices, which are not limitative of the present invention.

FIG. 2 shows a schematic side view of an optical lens device having an anti-fog thin film in accordance with a first preferred embodiment of the present invention. Referring now to FIG. 2, the optical lens device in accordance with the first preferred embodiment of the present invention includes an optical substrate layer 10, at least one optical adhesive layer 20 and at least one heat-setting-treated anti-fog film 30 which are combined to form a heat-setting-treated anti-fog optical lens device 1a. In another preferred embodiment, an optical enhancement material layer is provided between the optical substrate layer 10 and the optical adhesive layer 20, between the optical substrate layer 10 and the heat-setting-treated anti-fog film 30 or between the optical adhesive layer 20 and the heat-setting-treated anti-fog film 30.

With continued reference to FIG. 2, by way of example, the optical substrate layer 10 has a first uniform thickness and is selected from a glass substrate layer, a plastic substrate layer, an eco-friendly plastic substrate layer, a PC (polycarbonate) substrate layer, a PMMA (poly(methyl methacrylate) substrate layer, a PA (polyamide or Nylon) substrate layer, a COP (cyclic olefin polymer) substrate layer, a COC (cyclic olefin copolymer) substrate layer, a COB (cyclic block copolymer) substrate layer or made of similar materials thereof.

Still referring to FIG. 2, by way of example, the optical substrate layer 10 has a first front side surface 11 and a second rear side surface 12, with the first front side surface 11 of optical substrate layer 10 locating at an outer side while the second rear side surface 12 of optical substrate layer 10 locating at an inner side in use. Accordingly, high moisture of air mist, human body sweat moisture or breathing moisture of users are usually apt to generate clouding or fog on the second rear side surface 12 of optical substrate layer 10.

Still referring to FIG. 2, by way of example, the optical adhesive layer 20 is formed on a predetermined portion (e.g., center portion or peripheral portion) of the second rear side surface 12 of optical substrate layer 10 in a suitable manner (e.g., coating, spin-coating, single-layer or multi-layer spray-dispensing), with the optical adhesive layer 20 having a predetermined uniform thickness (e.g., about 240 μm), a predetermined hardness, a predetermined refractive index or other optical properties.

Still referring to FIG. 2, by way of example, a single layer or a multiple layers of the heat-setting-treated anti-fog film 30 is formed on a predetermined portion (e.g., center portion or peripheral portion) of the second rear side surface 12 of optical substrate layer 10 in a suitable manner, with the heat-setting-treated anti-fog film 30 providing an anti-fog property on the second rear side surface 12 of optical substrate layer 10 while a user wears it.

Still referring to FIG. 2, by way of example, in a preferred embodiment, a processed surface (e.g., thermal treatment or other treatment) of the heat-setting-treated anti-fog film 30 is perfectly adhered to a processed area (e.g., thermal treatment or other treatment of center portion or peripheral portion) of the second rear side surface 12 of optical substrate layer 10 via the optical adhesive layer 20 for enhancing an anti-fog effect.

FIG. 3 shows a schematic side view of an optical lens device having an anti-fog thin film in accordance with a second preferred embodiment of the present invention, corresponding to the device as best shown in FIG. 2. Turning now to FIG. 3, in comparison with the first embodiment, the optical lens device of the second preferred embodiment of the present invention includes an optical laminated substrate layer 10a, at least one optical adhesive layer 20, at least one heat-setting-treated anti-fog film 30 and at least one scratch-resistant layer 40 which are combined to form a heat-setting-treated anti-fog optical lens device 1b. In another preferred embodiment, an optical enhancement material layer is provided between the optical laminated substrate layer 10a and the optical adhesive layer 20, between the optical laminated substrate layer 10a and the heat-setting-treated anti-fog film 30 or between the optical adhesive layer 20 and the heat-setting-treated anti-fog film 30.

With continued reference to FIG. 3, by way of example, the optical laminated substrate layer 10a has a first front side surface 11 and a second rear side surface 12, with the optical laminated substrate layer 10a having a plurality of optical thin-film layers which are made of similar or dissimilar materials and laminated to form a composite optical substrate layer, with at least one of the optical thin-film layers selected from an optical functional layer, with the optical functional layer selected from a protective layer, an electroplating layer, a polarization microstructure layer, an anti-reflection layer, a polarization thin-film layer, a microstructure layer, a photochromic layer, an anti-blue layer, an anti-blue UV layer, an anti-infrared layer or combinations thereof.

Still referring to FIG. 3, by way of example, the scratch-resistant layer 40 is provided on the first front side surface 11 of optical substrate layer 10 in a suitable manner (e.g., adhesion, spraying, coating or others), with scratch-resistant layer 40 providing a degree of scratch resistance thereon to avoid occurrence of scratch on the optical laminated substrate layer 10a, with the scratch-resistant layer 40 selectively formed from an organic material strengthening layer, an organic and inorganic material strengthening layer, an inorganic material strengthening layer or equivalent layers.

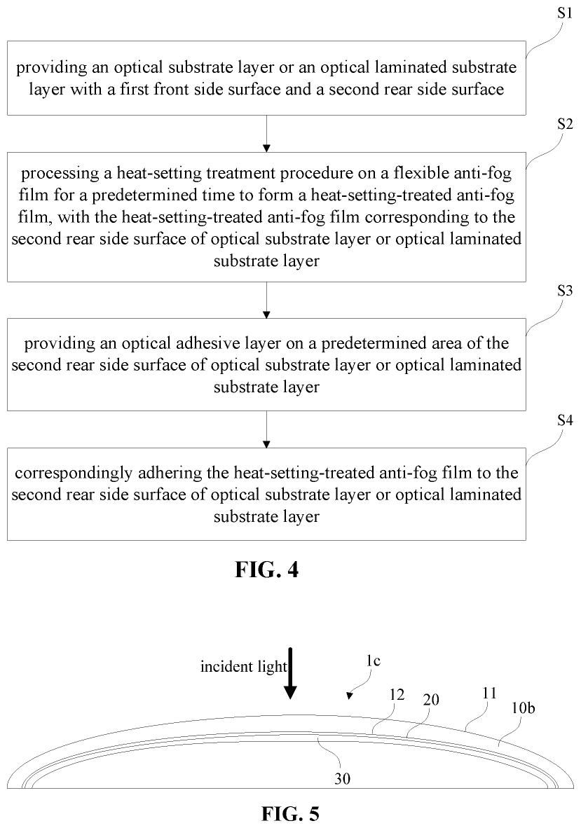

FIG. 4 shows a flow chart of a manufacturing method of the optical lens device having an anti-fog thin film in accordance with a preferred embodiment of the present invention, corresponding to the device as best shown in FIGS. 2 and 3. Turning now to FIGS. 2, 3 and 4, by way of example, the manufacturing method of optical lens device has a series of procedure (steps S1, S2, S3 and S4) which may be modified according to needs.

Referring now to FIGS. 2, 3 and 4, by way of example, the manufacturing method of optical lens device of the present invention includes the step S1: providing the optical substrate layer 10 or the optical laminated substrate layer 10a with the first front side surface 11 and the second rear side surface 12, with the first front side surface 11 corresponding to the second rear side surface 12.

Still referring to FIGS. 2, 3 and 4, by way of example, the manufacturing method of optical lens device of the present invention includes the step S2: processing a heat-setting treatment procedure on a flexible anti-fog film (having a predetermined degree of softness and flexibility) for a predetermined time to form the heat-setting-treated anti-fog film 30 (a predetermined degree of hardness), with the heat-setting-treated anti-fog film 30 corresponding to the second rear side surface 12 of optical substrate layer 10 or optical laminated substrate layer 10a.

Still referring to FIGS. 2, 3 and 4, by way of example, the flexible anti-fog film has a first uniform thickness (e.g., about 10 mm or other suitable thickness) and is selected from a PP material film, a PET (polyethylene terephthalates) material film, a TAC (tri-acetyl cellulose) material film or combinations thereof.

Still referring to FIGS. 2, 3 and 4, by way of example, the heat-setting treatment procedure is process in a predetermined temperature ranging between about 100° C. to about 140° C. or other suitable temperature ranges for a predetermined processing time about 1 minute to 40 minutes or other suitable time.

Still referring to FIGS. 2, 3 and 4, by way of example, the flexible anti-fog film has a front side surface and a rear side surface, with processing the heat-setting treatment procedure on the front side surface (e.g., partial surface or entire surface), the rear side surface (e.g., partial surface or entire surface) or both surfaces of flexible anti-fog film.

Still referring to FIGS. 2, 3 and 4, by way of example, the heat-setting-treated anti-fog film 30 is selectively formed with a flat surface heat-setting-treated film, a curved surface heat-setting-treated film, a hyperbola surface heat-setting-treated film, a spherical surface heat-setting-treated film or an aspherical surface heat-setting-treated film by processing the heat-setting treatment procedure.

As mentioned above, the term “aspherical surface” defines a form of non-spherical surface from a center portion to a peripheral edge portion, with the non-spherical surface having a variable curvature varying from a center portion to a peripheral edge portion so as to provide an optical characteristic different from that of spherical surface.

FIG. 5 shows a schematic side view of an optical lens device having an anti-fog thin film in accordance with a third preferred embodiment of the present invention, corresponding to the device as best shown in FIGS. 2 and 3. Turning now to FIG. 5, in comparison with the first embodiment, the optical lens device of the third preferred embodiment of the present invention includes an ellipsoid surface optical substrate layer 10b, at least one optical adhesive layer 20 and at least one heat-setting-treated anti-fog film 30 which are combined to form a heat-setting-treated anti-fog optical lens device 1c.

With continued reference to FIG. 5, by way of example, the ellipsoid surface optical substrate layer 10b has an ellipsoid-shaped surface, with processing a heat-setting treatment procedure on the flexible anti-fog film to form the heat-setting-treated anti-fog film 30 with an ellipsoid-shaped surface or other suitable shaped surfaces, with the ellipsoid-shaped surface of heat-setting-treated anti-fog film 30 corresponding to that of ellipsoid surface optical substrate layer 10b.

Referring now to FIGS. 2, 3 and 4, by way of example, the manufacturing method of optical lens device of the present invention includes the step S3: providing the optical adhesive layer 20 on the predetermined area (e.g., center portion or peripheral portion) of the second rear side surface 12 of optical substrate layer 10 or optical laminated substrate layer 10a.

Referring now to FIGS. 2, 3 and 4, by way of example, the manufacturing method of optical lens device of the present invention includes the step S4: correspondingly adhering the heat-setting-treated anti-fog film 30 to the second rear side surface 12 of optical substrate layer 10 or optical laminated substrate layer 10a (e.g., processed surface of optical substrate layer or processed optical thin-film layer of optical laminated substrate layer).

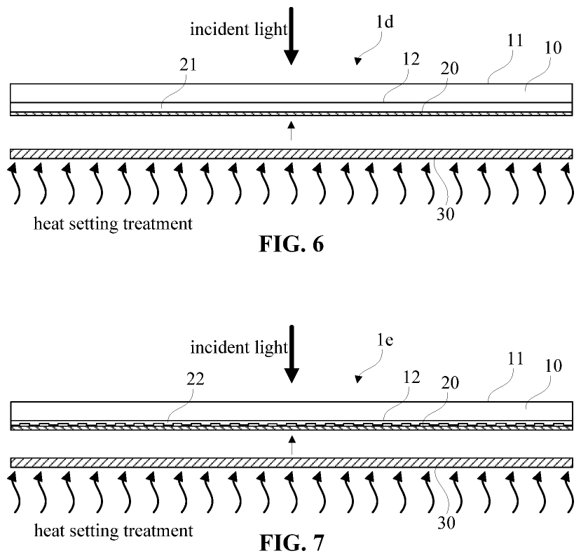

FIG. 6 shows a schematic side view of an optical lens device having an anti-fog thin film in accordance with a fourth preferred embodiment of the present invention, corresponding to the devices as best shown in FIGS. 2 and 3. Turning now to FIG. 6, in comparison with the first and second embodiments, the optical lens device of the fourth preferred embodiment of the present invention further includes an optional functional layer 21 provided on the second rear side surface 12 of optical substrate layer 10 (or optical laminated substrate layer 10a), with the optional functional layer 21 provided between the optical adhesive layer 20 and the heat-setting-treated anti-fog film 30, such that the optical substrate layer 10, the optical adhesive layer 20, the optional functional layer 21 and the heat-setting-treated anti-fog film 30 are combined in order to form a heat-setting-treated anti-fog optical lens device 1d.

With continued reference to FIG. 6, by way of example, the optional functional layer 21 is selected from a protective layer, an electroplating layer, a polarization microstructure layer, an anti-reflection layer, a polarization thin-film layer, a microstructure layer, a photochromic layer, an anti-blue layer, an anti-blue UV layer, an anti-infrared layer or combinations thereof, with the optional functional layer 21 having a predetermined transmittance incorporating with that of the second rear side surface 12 of optical substrate layer 10 (or optical laminated substrate layer).

Still referring to FIG. 6, by way of example, the optional functional layer 21 is formed on the second rear side surface 12 of optical substrate layer 10 (or optical laminated substrate layer) in a suitable manner (e.g., electroplating or multi-layer electroplating). In using the heat-setting-treated anti-fog optical lens device 1d, the optional functional layer 21 is capable of providing an optical function on the second rear side surface 12 of optical substrate layer 10 (or optical laminated substrate layer).

Still referring to FIG. 6, by way of example, in another preferred embodiment an optical enhancement material layer is provided between the optical substrate layer 10 (or optical laminated substrate layer) and the optional functional layer 21, between the optional functional layer 21 and the heat-setting-treated anti-fog film 30, or between the optical adhesive layer 20 and the heat-setting-treated anti-fog film 30.

FIG. 7 shows a schematic side view of an optical lens device having an anti-fog thin film in accordance with a fifth preferred embodiment of the present invention, corresponding to the device as best shown in FIG. 2. Turning now to FIG. 7, in comparison with the first embodiment, the optical lens device of the fifth preferred embodiment of the present invention includes an optical substrate layer 10, an optical adhesive layer 20, a microstructure layer 22 and a heat-setting-treated anti-fog film 30 are combined in order to form a heat-setting-treated anti-fog optical lens device 1e.

With continued reference to FIG. 7, by way of example, the microstructure layer 22 is integrated with the first front side surface 11 of optical substrate layer 10 (or optical laminated substrate layer), the second rear side surface 12 of optical substrate layer 10 (or optical laminated substrate layer) or both, and is further combined with at least one scratch-resistant protective layer to strengthen a structural strength thereof.

Although the invention has been described in detail with reference to its presently preferred embodiment, it will be understood by one of ordinary skills in the art that various modifications can be made without departing from the spirit and the scope of the invention, as set forth in the appended claims.

What is claimed is:

1. An optical lens device comprising:
an optical substrate layer provided with a first front side surface and a second rear side surface;
at least one optical adhesive layer provided on a predetermined area of the second rear side surface of optical substrate layer; and
at least one heat-setting-treated anti-fog film formed by processing a heat-setting treatment procedure on a flexible anti-fog film for a predetermined time, with the heat-setting-treated anti-fog film corresponding to the second rear side surface of optical substrate layer, with the heat-setting-treated anti-fog film correspondingly adhering to the second rear side surface of optical substrate layer;
wherein the heat-setting-treated anti-fog film provides an anti-fog function on the second rear side surface of optical substrate layer, with a combination of the heat-setting-treated anti-fog film and the second rear side surface of optical substrate layer enhancing an entire structure.

2. The optical lens device as defined in claim 1, wherein the optical substrate layer is selected from a glass substrate layer, a plastic substrate layer, an eco-friendly plastic substrate layer, a PC substrate layer, a PMMA substrate layer, a PA substrate layer, a COP substrate layer, a COC substrate layer, a COB substrate layer or combinations thereof.

3. The optical lens device as defined in claim 1, wherein the flexible anti-fog film is selected from a PP material film, a PET material film, a TAC material film or combinations thereof.

4. The optical lens device as defined in claim 1, wherein the heat-setting-treated anti-fog film is selectively formed with a flat surface heat-setting-treated film, a curved surface heat-setting-treated film, a hyperbola surface heat-setting-treated film, a spherical surface heat-setting-treated film or an aspherical surface heat-setting-treated film by processing the heat-setting treatment procedure.

5. The optical lens device as defined in claim 1, wherein the second rear side surface of optical substrate layer further includes an optical functional layer, with the optical functional layer selected from a protective layer, an electroplating layer, a polarization microstructure layer, an anti-reflection layer, a polarization thin-film layer, a microstructure layer, a photochromic layer, an anti-blue layer, an anti-blue UV layer, an anti-infrared layer or combinations thereof.

6. An optical lens device comprising:
an optical laminated substrate layer provided with a first front side surface and a second rear side surface, with the optical laminated substrate layer having a plurality of optical thin-film layers;
at least one optical adhesive layer provided on a predetermined area of the second rear side surface of optical laminated substrate layer; and
at least one heat-setting-treated anti-fog film formed by processing a heat-setting treatment procedure on a flexible anti-fog film for a predetermined time, with the heat-setting-treated anti-fog film corresponding to the second rear side surface of optical laminated substrate layer, with the heat-setting-treated anti-fog film correspondingly adhering to the second rear side surface of optical laminated substrate layer;
wherein the heat-setting-treated anti-fog film provides an anti-fog function on the second rear side surface of optical laminated substrate layer, with a combination of the heat-setting-treated anti-fog film and the second rear side surface of optical laminated substrate layer enhancing an entire structure.

7. The optical lens device as defined in claim 6, wherein the optical laminated substrate layer is selected from a glass substrate layer, a plastic substrate layer, an eco-friendly plastic substrate layer, a PC substrate layer, a PMMA substrate layer, a PA substrate layer, a COP substrate layer, a COC substrate layer, a COB substrate layer or combinations thereof.

8. The optical lens device as defined in claim 6, wherein the flexible anti-fog film is selected from a PP material film, a PET material film, a TAC material film or combinations thereof.

9. The optical lens device as defined in claim 6, wherein the heat-setting-treated anti-fog film is selectively formed with a flat surface heat-setting-treated film, a curved surface heat-setting-treated film, a hyperbola surface heat-setting-treated film, a spherical surface heat-setting-treated film or an aspherical surface heat-setting-treated film by processing the heat-setting treatment procedure.

10. The optical lens device as defined in claim 6, wherein the second rear side surface of optical laminated substrate layer further includes an optical functional layer, with the optical functional layer selected from a protective layer, an electroplating layer, a polarization microstructure layer, an anti-reflection layer, a polarization thin-film layer, a microstructure layer, a photochromic layer, an anti-blue layer, an anti-blue UV layer, an anti-infrared layer or combinations thereof.

11. The optical lens device as defined in claim 6, wherein one of the optical thin-film layers of optical laminated substrate layer is selected from an optical functional layer, with the optical functional layer selected from a protective layer, an electroplating layer, a polarization microstructure layer, an anti-reflection layer, a polarization thin-film layer, a microstructure layer, a photochromic layer, an anti-blue layer, an anti-blue UV layer, an anti-infrared layer or combinations thereof.

12. A manufacturing method of an optical lens device comprising:
providing an optical substrate layer or an optical laminated substrate layer with a first front side surface and a second rear side surface;
processing a heat-setting treatment procedure on a flexible anti-fog film for a predetermined time to form a heat-setting-treated anti-fog film, with the heat-setting-treated anti-fog film corresponding to the second rear side surface of optical substrate layer or optical laminated substrate layer;
providing an optical adhesive layer on predetermined area of the second rear side surface of optical substrate layer or optical laminated substrate layer; and
correspondingly adhering the heat-setting-treated anti-fog film to the second rear side surface of optical substrate layer or optical laminated substrate layer.

13. The method as defined in claim 12, wherein the heat-setting-treated anti-fog film is selectively formed with a flat surface heat-setting-treated film, a curved surface heat-setting-treated film, a hyperbola surface heat-setting-treated film, a spherical surface heat-setting-treated film or an aspherical surface heat-setting-treated film by processing the heat-setting treatment procedure.

14. The method as defined in claim 12, wherein the heat-setting treatment procedure is processed in a predetermined temperature ranging between 100° C. to 140° C.

15. The method as defined in claim 12, wherein the predetermined time of heat-setting treatment procedure ranges is about 1 minute to 40 minute.

16. The method as defined in claim 12, wherein the flexible anti-fog film has a front side surface and a rear side surface, with selectively processing the heat-setting treatment procedure on the front side surface, the rear side surface or both.
